(19) United States
(12) Patent Application Publication
(10) Pub. No.: US 2009/0280800 A1
(43) Pub. Date: Nov. 12, 2009

(54) TESTING SYSTEM AND METHOD FOR TESTING MOBILE PHONE

(75) Inventors: Qing-Hua Liu, Shenzhen City (CN); Yi-Bo Liu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/171,426

(22) Filed: Jul. 11, 2008

(30) Foreign Application Priority Data
May 6, 2008 (CN) 200810301437.3

(51) Int. Cl. H04M 1/00; H04R 29/00

(52) U.S. Cl. 455/425; 381/59

(57) ABSTRACT

A testing system includes a portable device with a speaker and a computer connected to the portable device. The computer includes a testing procedure capable of sending test instructions to the portable device. In response to receiving the test instructions the portable device sends commands to the speaker to instruct the speaker emitting audio. The computer is capable of registering audio from the speaker and comparing the audio with predetermined audio parameters. A testing method of a mobile phone utilizing above described testing system is also disclosed.

### BACKGROUND

1. Technical Field

The present invention relates to testing systems and methods for testing electronic devices, and more particularly to a testing system and method for testing a mobile phone.

2. Description of Related Art

In order to provide users qualified mobile phones, the mobile phones are tested before going to market. It's a necessary step to test audio functions (voice communication, radio, voice recorder, MP3, etc.) of the mobile phones. A conventional method to test audio functions of a mobile phone includes having an operator listening to voice communication over the phone, the radio, the recorder, and the MP3 of the mobile phone; and judging whether the output of the mobile phone is qualified. The above described method requires few test fixtures and can be easily performed. However, the test results are subjective and so are not highly accurate.

What is needed, therefore, is a testing system and method for accurately testing a mobile phone.

### BRIEF DESCRIPTION OF THE DRAWINGS

FIG. 1 is a testing system for testing a mobile phone; and

FIG. 2 is a flow chart of a testing method for testing a mobile phone.

### DETAILED DESCRIPTION

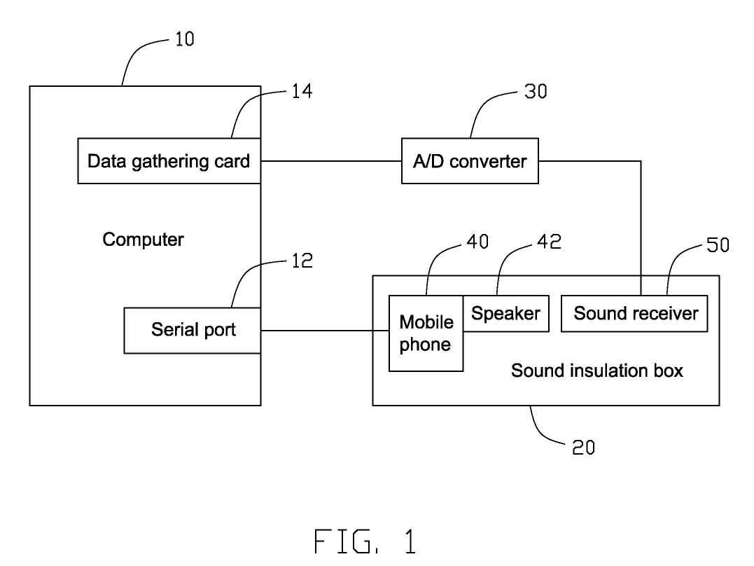

Referring to FIG. 1, a testing system in accordance with an exemplary embodiment of the present invention includes a computer 10, an insulated sound box 20, and an Analog/Digital converter (A/D converter) 30. A mobile phone 40 to be tested and a sound receiver 50 are placed in the insulated sound box 20.

The computer 10 includes a serial port 12 which is a serial communication physical interface through which information transfers in or out one bit at a time, and a data gathering card 14 connected with an output terminal of the A/D converter 30. The mobile phone 40 includes a speaker 42 capable of broadcasting audio signals to the sound receiver 50. The sound receiver 50 is connected with an input terminal of the A/D converter 30.

The computer 10 has a test procedure therein for sending test instructions to the mobile phone 40 and for judging whether audio output of the mobile phone 40 is qualified. There are predetermined audio parameters (frequency, amplitude etc.) set up in the test procedure. The predetermined audio parameters are theory summarized or determined according to a plurality of audio signals sent out by qualified mobile phones.

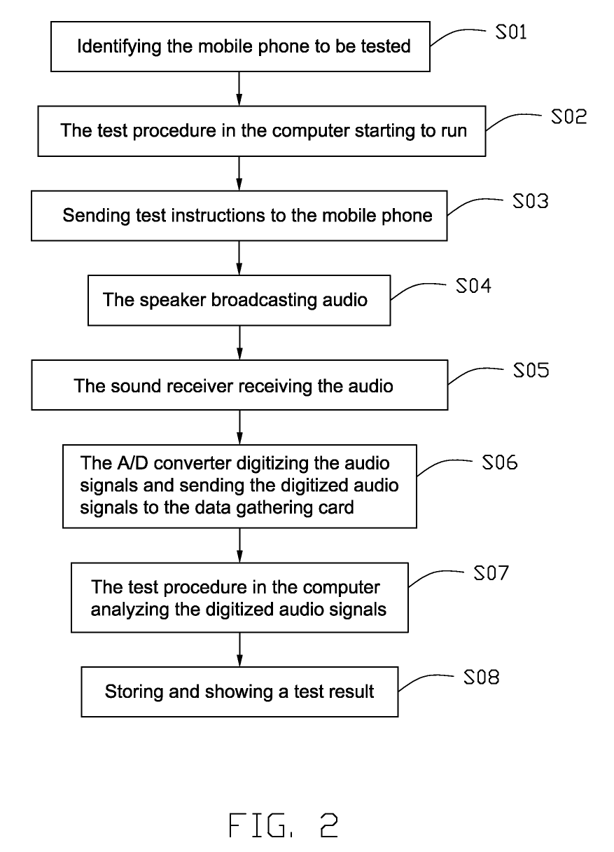

Referring to FIG. 2, a testing method for testing a mobile phone utilizing above described testing system includes steps of:

S01: identifying the mobile phone 40 to be tested;

S02: the test procedure in the computer 10 starting to run;

S03: the computer 10 sending test instructions to the mobile phone 40 via its serial port 12;

S04: the speaker 42 of the mobile phone 40 broadcasting audio (voice communication, radio, or MP3) after receiving the test instructions;

S05: the sound receiver 50 receiving the audio broadcasted by the speaker 42 and transferring analog audio signals to the A/D converter 30;

S06: the A/D converter 30 digitizing the analog audio signals and outputting the digitized audio signals to the data gathering card 14 of the computer 10;

S07: the test procedure in the computer 10 analyzing the digitized audio signals by a manner of comparing the digitized audio signals with the predetermined audio parameters; and

S08: the computer 10 storing and showing the test result; if the digitized audio signals are consistent with the predetermined parameters, the computer 10 showing a message such as PASS on its screen; if the digitized audio signals are not consistent with the predetermined parameters, the computer 10 showing a message such as FAIL on its screen.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A testing system comprising:
a portable device comprising a speaker; and
a computer connected to the portable device;
wherein the computer comprises of a testing procedure capable of sending test instructions to the portable device; in response to receiving the test instructions the portable device sends commands to the speaker to instruct the speaker to emit audio;
the computer is capable of registering the audio and comparing the audio with predetermined audio parameters.

2. The testing system as described in claim 1, further comprising a sound receiver in proximity to the speaker.

3. The testing system as described in claim 2, further comprising an analog/digital converter capable of converting analog signals received from the sound receiver to digital signals.

4. The testing system as described in claim 3, wherein the computer further comprises a data gathering card connected with the analog/digital converter, the data gathering card is capable of gathering the digital signals from the analog/digital converter.

5. The testing system as described in claim 1, wherein the computer further comprises a serial port connecting with the portable device for sending the test instructions to the portable device.

6. The testing system as described in claim 2, further comprising an insulated sound box in which the portable device and the sound receiver is accommodated.

7. A testing method for testing the audio of a portable device comprising steps of:
sending test instructions to the portable device from a computer to instruct the portable device to emit audio;
comparing the audio with predetermined audio parameters; and
determining whether the audio meets a predetermined standard.

8. The testing method as described in claim 7, wherein the comparing is done by the computer.

9. The testing method as described in claim 7, further comprising a step of receiving the audio from the portable device by a sound receiver in proximity to the portable device.

10. The testing method as described in claim 9, further comprising converting audio signals from the sound receiver to digital signals.

11. The testing method as described in claim 10, further comprising gathering the digital signals by a data gathering card installed in the computer.

12. The testing method as described in claim 11, wherein comparing uses the digital signals gathered by the data gathering card.

13. The testing method as described in claim 9, further comprising insulating the portable device in an insulated sound box, the portable device and the sound receiver are placed in the insulated sound box.

14. The testing method as described in claim 7, wherein the test instructions is sent to the portable device via a serial port of the computer.

15. A testing system comprising:
a mobile phone comprising a speaker; and
a computer having an output port connected with the mobile phone to send test instructions to the mobile phone and an input port capable of receiving the audio signals from the mobile phone, the computer having a test procedure therein and capable of sending the test instructions to the mobile phone to instruct the mobile phone to emit audio, and the computer is capable of comparing the audio with predetermined parameters to determine whether audio output of the mobile phone is qualified.

16. The testing system as described in claim 15, further comprising a sound receiver in proximity to the speaker to receive the audio signals from the mobile phone.

17. The testing system as described in claim 16, further comprising an analog/digital converter connecting the sound receiver and the input port of the computer capable of digitizing the audio received by the sound receiver and sending the digitized audio signals to the computer.

18. The testing system as described in claim 17, wherein the computer comprises a data gathering card connected with the analog/digital converter capable of gathering the digitized audio signals from the analog/digital converter.

19. The testing system as described in claim 15, wherein the output port of the computer is a serial port.

20. The testing system as described in claim 15, further comprising an insulated sound box in which the mobile phone and the sound receiver is accommodated.
